(19) United States
(12) Patent Application Publication
(10) Pub. No.: US 2025/0008369 A1
(43) Pub. Date: Jan. 2, 2025

(54) QUALITY OF SERVICE FLOW SCHEDULING METHOD AND APPARATUS, NETWORK DEVICE, AND STORAGE MEDIUM

(71) Applicant: Beijing Xiaomi Mobile Software Co., Ltd., Beijing (CN)

(72) Inventor: Yanhua LI, Beijing (CN)

(73) Assignee: Beijing Xiaomi Mobile Software Co., Ltd., Beijing (CN)

(21) Appl. No.: 18/291,356

(22) PCT Filed: Jul. 23, 2021
(86) PCT No.: PCT/CN2021/108247

§ 371 Date: Jan. 23, 2024

(51) Int. Cl. H04W 28/02; H04W 72/543

(52) U.S. Cl. CPC H04W 28/0268; H04W 72/543

(57) ABSTRACT

A QoS flow scheduling method, apparatus and computer readable medium that improve utilization of network resources in a wireless communication network. The utilization of network resources is improved by: determining a candidate configuration set for a QoS flow, where the candidate configuration set includes a plurality of parameter configurations for the QoS flow.

### CROSS-REFERENCE TO RELATED APPLICATION

This application is the U.S. national phase application of International Application No. PCT/CN2021/108247, filed on Jul. 23, 2021, the disclosure of which is incorporated herein by reference in its entirety for all purposes.

### TECHNICAL FIELD

The present disclosure relates to but is not limited to the field of wireless communication technologies, and, in particular, relates to a quality of service (QOS) flow scheduling method and apparatus, a network device, and a storage medium.

### BACKGROUND

Every QoS flow is defined with a QoS configuration. The QoS configuration includes one or more QoS parameters. These QoS parameters specify some characteristics of the QoS flow that are expected to be met. These QoS parameters include but are not limited to 5G QoS Indicator (QI), Priority Level, Reflective QoS Attribute, Packet Delay Budget, etc.

As an example, the QoS flow may be categorized into a guaranteed bit rate (GBR) QoS flow and a non-GRB QoS flow.

Generally, a base station, as an access network device, schedules and allocates the corresponding QoS resources according to the QoS configuration of the QoS flow. In the art, however, a core network only provides one parameter configuration for the QoS flow to the base station.

### SUMMARY

Examples of the present disclosure provide a QoS scheduling method and apparatus, a network device, and a storage medium.

A QOS flow scheduling method is provided in a first aspect of the examples of the present disclosure, which is performed by a first network device. The method includes: determining a candidate configuration set for a QoS flow, wherein the candidate configuration set includes a plurality of parameter configurations for the QoS flow.

A QOS flow scheduling method is provided in a second aspect of the examples of the present disclosure, which is performed by a second network device. The method includes: transmitting a QoS request message indicating a candidate configuration set for a QoS flow, wherein the candidate configuration set includes a plurality of parameter configurations for the QoS flow.

A network device is provided in a third aspect of the examples of the present disclosure and includes a processor, a transceiver, a memory, and an executable program stored on the memory and capable of being run by the processor. The processor, when running the executable program, performs: determining a candidate configuration set for a QoS flow, wherein the candidate configuration set includes a plurality of parameter configurations for the QoS flow.

It is to be understood that the above general description and the following detailed description are only illustrative and explanatory, and are not intended to limit the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 illustrates a schematic structural diagram of a wireless communication system according to an example.

FIG. 2A illustrates a schematic flowchart of a QoS flow scheduling method according to an example.

FIG. 2B illustrates a schematic flowchart of a QoS flow scheduling method according to an example.

FIG. 3A illustrates a schematic flowchart of a QoS flow scheduling method according to an example.

FIG. 3B illustrates a schematic flowchart of a QoS flow scheduling method according to an example.

FIG. 4 illustrates a schematic flowchart of a QoS flow scheduling method according to an example.

FIG. 5 illustrates a schematic flowchart of a QoS flow scheduling method according to an example.

FIG. 6 illustrates a schematic flowchart of a QoS flow scheduling method according to an example.

FIG. 7 illustrates a schematic structural diagram of a QoS flow scheduling apparatus according to an example.

FIG. 8 illustrates a schematic structural diagram of a QoS flow scheduling apparatus according to an example.

FIG. 9 illustrates a schematic structural diagram of a network device according to an example.

### DETAILED DESCRIPTION OF THE EMBODIMENTS

Embodiments will be described in detail here with the examples thereof illustrated in the drawings. Where the following descriptions involve the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

The terms used in the present disclosure are for the purpose of describing particular examples only, and are not intended to limit the present disclosure. Terms determined by “a”, “said” and “the” in their singular forms used in the examples of the present disclosure and the appended claims are also intended to include their plural forms, unless clearly indicated otherwise in the context. It is also to be understood that the term “and/or” as used herein is and includes any and all possible combinations of one or more of the associated listed items.

It is to be understood that, although terms “first,” “second,” “third,” and the like may be adopted in the examples of the present disclosure to describe various information, such information should not be limited to these terms. These terms are only used to distinguish the information of the same type with each other. For example, without departing from the scope of the examples of the present disclosure, first information may be referred as second information; and similarly, second information may also be referred as first information. Depending on the context, the word “if” as used herein may be interpreted as “when,” “upon,” or “in response to determining.”

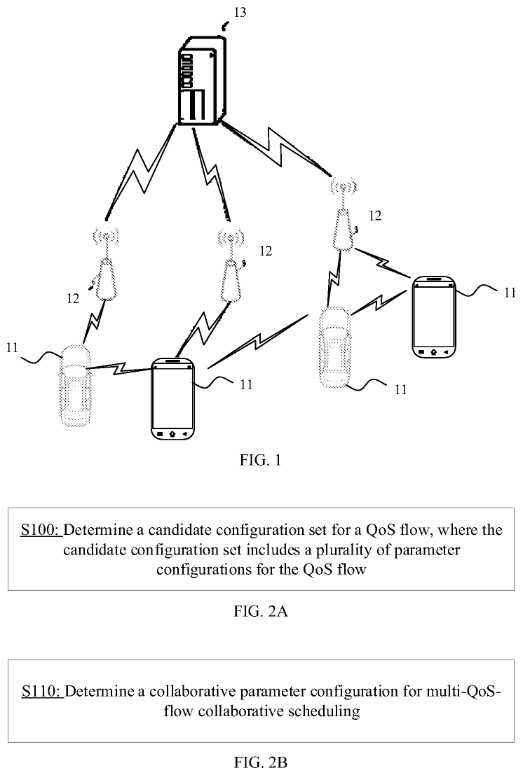

Please refer to FIG. 1, which illustrates a schematic structural diagram of a wireless communication system provided by an example of the present disclosure. As illustrated in FIG. 1, the wireless communication system is a communication system based on cellular mobile communication technologies, and may include several user equipment (UE) 11 and several access devices 12.

The UE 11 may refer to a device that provides voice and/or data connectivity for a user. The UE 11 may communicate with one or more core networks via a radio access network (RAN). The UE 11 may be an Internet of Things UE, such as a sensor device, a mobile phone (or called a “cellular” phone), and a computer equipped with the Internet of Things UE, which may, for example, be a fixed, portable, pocket-sized, handheld, computer-built-in or vehicle-mounted device. For example, the UE 11 may be a station (STA), a subscriber unit, a subscriber station, a mobile station, a mobile, a remote station, an access point, a remote UE (remote terminal), an access UE (access terminal), a user terminal, a user agent, or a user device. The UE 11 may be a device like an unmanned drone. The UE 11 may be a vehicle-mounted device, for example, an on-board computer with a wireless communication function or a wireless communication device connected to the on-board computer. The UE 11 may be a roadside device, for example, a street lamp, signal lamp or another roadside device with a wireless communication function.

The access device 12 may be a network side device in the wireless communication system. The wireless communication system may be a 4th generation mobile communication (4G) system, which is also known as a Long Term Evolution (LTE) system. The wireless communication system may be a 5G system, which is also known as a New Radio (NR) system or a 5G NR system. The wireless communication system may be a next-generation system of the 5G system. The access network in the 5G system may be called a New Generation-Radio Access Network (NG-RAN). The wireless communication system may be a machine type communication (MTC) system.

The access device 12 may be an evolved access device (eNB) adopted in the 4G system. Alternatively, the access device 12 may be an access device (gNB) using a centralized and distributed architecture in the 5G system. When using the centralized and distributed architecture, the access device 12 usually includes a central unit (CU) and at least two distributed units (DU). The CU is provided with a protocol stack including a packet data convergence protocol (PDCP) layer, a radio link control (RLC) protocol layer and a media access control (MAC) layer. The DU is provided with a protocol stack including a physical (PHY) layer. The examples of the present disclosure do not limit the specific implementation of the access device 12.

A wireless connection may be established between the access device 12 and the UE 11 through a wireless air interface. In different implementations, the wireless air interface is based on the 4G standards, based on the 5G standards, for example, a new radio, or based on next-generation mobile communication network technology standards of 5G.

In some examples, an end to end (E2E) connection may also be established between UE 11, for example, in a circumstance of a vehicle-to-everything (V2X) communication such as a vehicle-to-vehicle (V2V) communication, a vehicle-to-infrastructure (V2I) communication and a vehicle-to-pedestrian (V2P) communication.

In some examples, the above wireless communication system may further include a network management device 13.

Several access devices 12 are connected to the network management device 13 separately. The network management device 13 may be a core network device in the wireless communication system. For example, the network management device 13 may be a mobility management entity (MME) in an evolved packet core (EPC) network. The network management device may be another core network device, such as a serving gateway (SGW), a public data network gateway (PGW), a policy and charging rules function (PCRF) unit or a home subscriber server (HSS). The implemented forms of the network management device 13 are not limited by the examples of the present disclosure.

As illustrated in FIG. 2A, an example of the present disclosure, provides a quality of service (QOS) flow scheduling method, which is performed by a first network device. The method may include step S100.

At S100, a candidate configuration set is determined for a QoS flow, where the candidate configuration set includes a plurality of parameter configurations for the QoS flow.

The first network device may be an access network device. As an example, the access network device includes but is not limited to a base station. The base station may be an eNB or a gNB.

A parameter configuration here may include one or more QoS parameters of a QoS configuration. The QoS parameters include but are not limited to Guaranteed Bit Rate (GBR), Reflective QoS Attribute, Packet Delay Budget, Priority Level and/or 5G QoS Indicator (5QI).

These QoS parameters may be used by the base station to schedule and allocate resources for the QoS flow.

The candidate configuration set includes at least one of: one or more collaborative parameter configurations or one or more non-collaborative parameter configurations. The collaborative parameter configuration is a parameter configuration for multi-QoS-flow collaborative scheduling. The non-collaborative parameter configuration is a parameter configuration for independently scheduling the QoS flow.

The collaborative parameter configuration is the parameter configuration for multi-QoS-flow collaborative scheduling. For example, two or more QoS flows are associated, and QoS values of some of these QoS flows affect the quality of a business or a service provided by these QoS flows. Thereby, in order to ensure the communication quality of the business or the service, e.g., one or more of a small enough delay, a high enough rate, a low enough bit error rate and the like, these QoS flows are required to be collaboratively scheduled. The parameter configuration adopted in this case may be different from that adopted in a non-collaborative scenario, for example, it has more stringent requirement for the delay. In this case, the parameter configuration is the collaborative parameter configuration.

As an example, without being collaboratively scheduled, the two or more QoS flows adopt their parameter configurations, respectively. The parameter configuration includes one or more QoS parameters. The QoS parameters are specifically defined in Table 1 to Table 3 below, such as Parameter Configuration 1 and Parameter Configuration 2. However, in a collaborative scheduling scenario, these QoS flows are to adopt their collaborative scheduling parameter configurations, Parameter Configuration 1′ and Parameter Configuration 2′, respectively. In this case, for QoS Flow 1, its candidate configuration set includes a plurality of parameter configurations, i.e., Parameter Configuration 1 and Parameter Configuration 1′; and for QoS Flow 2, its candidate configuration set includes a plurality of parameter configurations, i.e., Parameter Configuration 2 and Parameter Configuration 2′.

The non-collaborative parameter configuration is also called independent scheduling parameter configuration, which is adopted for independently scheduling each QoS flow. In the independent scheduling scenario, the first network device is to independently schedule each Qos flow. For example, the independent scheduling is performed by considering the conditions of the QoS flow itself, like the QoS value, etc.

As an example, there may be a plurality of candidate configurations for the QoS flow in the independent scheduling scenario, Parameter Configuration X1 and Parameter Configuration X2. Parameter Configuration X2 is adopted when the network detects an abnormality, and Parameter Configuration X1 is adopted in other scenarios.

In one example, there may be one or more collaborative parameter configurations and/or one or more non-collaborative parameter configurations.

In one example, for the QoS flow that is determined only to be independently scheduled, for example, a typical service for providing traditional voice calls for a user, its candidate configuration set may include a plurality of non-collaborative parameter configurations, but exclude the collaborative parameter configuration.

In another example, for a multi-modal service of a multi-modal device, it may only be collaboratively scheduled, instead of being independently scheduled. Its candidate configuration set may include a plurality of collaborative parameter configurations, but exclude the non-collaborative parameter configuration.

In another example, for the QoS flow that is not only independently scheduled but also collaboratively scheduled, its candidate parameter configuration set may include both one or more collaborative parameter configurations and one or more non-collaborative parameter configurations. As an example, the candidate parameter configuration set includes: at least one non-collaborative parameter configuration and at least one collaborative parameter configuration.

In an example of the present disclosure, the candidate configuration set includes the plurality of parameter configurations. These parameter configurations may include any one of the aforementioned collaborative parameter configurations and non-collaborative parameter configurations. Specifically, which parameter configurations are included may be determined based on a scheduling circumstance and/or possible scheduling scenarios of the QoS flow.

In an example, for example, the one or more non-collaborative parameter configurations include a plurality of parameter configurations for independently scheduling the QoS flow in different scenarios.

For example, different independent scheduling scenarios may include at least one of the following scenarios: independent scheduling scenarios corresponding to different network states; independent scheduling scenarios corresponding to different UE states; or independent scheduling scenarios corresponding to different service subscribing conditions.

In some cases where there is a large network remaining bandwidth, the QoS flow of a high-definition video may be supported. Thus, in the independent scheduling scenario, the parameter configuration with a high QoS value may be selected for independently scheduling the QoS flow, thereby improving the effective utilization of network resources.

In some other cases where the UE has few remaining resources, the QoS value of the QoS flow may be appropriately reduced. For example, when the definition of the QoS flow for the video is appropriately reduced to improve a stuttering situation during playing the video, the parameter configuration with a lower QoS value may be selected for independently scheduling the QoS flow.

In some other cases based on subscription information between a user and an operator, the parameter configuration with a high QoS value may adopted for performing the independent scheduling if a business service with the high QoS value has been subscribed to, and otherwise, the parameter configuration with the lower QoS value may adopted for performing the independent scheduling.

As illustrated in FIG. 2B, an example of the present disclosure, provides a QoS flow scheduling method, which is performed by the first network device. The method may include step S110.

At S110, a collaborative parameter configuration for multi-QoS-flow collaborative scheduling is determined.

As an example, the collaborative parameter configuration is a parameter configuration for a QoS flow scheduled collaboratively with one or more other QoS flows. The parameter configuration here may include one or more QoS parameters of a QoS configuration. The QoS parameters include but are not limited to GBR, Reflective QoS Attribute, Packet Delay Budget, Priority Level and/or 5QI.

As an example, the non-collaborative parameter configuration is a parameter configuration from which the QoS flow is switched to another candidate QoS parameter configuration when a trigger event is confirmed. The parameter configuration here may include one or more QoS parameters of a QoS configuration. The QoS parameters include but are not limited to GBR, Reflective QoS Attribute, Packet Delay Budget, Priority Level and/or 5QI.

For example, the foregoing QoS parameters may be as shown in any one of Table 1 to Table 3.

TABLE 1

| | | | | | | |
|---|---|---|---|---|---|---|
| Information | | | IE type | | | |
| Element | | | and | Semantics | | Assigned |
| (IE)/Group Name | Presence | Range | reference | description | Criticality | Criticality |

| | | | | |
|---|---|---|---|---|
| CHOICE QoS | M | | | — |
| Characteristics | | | | |
| >Non-dynamic | | | | |
| 5QI | | | | |
| >>Non-dynamic | M | 9.3.1.28 | | — |
| 5QI Descriptor | | | | |
| >Dynamic 5QI | | | | |
| >> Dynamic 5QI | M | 9.3.1.18 | | — |
| Descriptor | | | | |
| Allocation and | M | 9.3.1.19 | | — |
| Retention Priority | | | | |
| GBR QoS Flow | O | 9.3.1.10 | This IE shall | — |
| Information | | | be present for | |
| | | | GBR QoS | |
| | | | flows and is | |
| | | | ignored | |
| | | | otherwise. | |
| Reflective QoS | O | ENUMERATED | This IE may | — |
| Attribute | | (subject | be present in | |
| | | to, . . .) | case of Non- | |
| | | | GBR QoS | |
| | | | flows and is | |
| | | | ignored | |
| | | | otherwise. | |
| Additional QoS | O | ENUMERATED | This IE | — |
| Flow Information | | (more | indicates that | |
| | | likely, . . .) | traffic for this | |
| | | | QoS flow is | |
| | | | likely to | |
| | | | appear more | |
| | | | often than | |
| | | | traffic for | |
| | | | other flows | |
| | | | established for | |
| | | | the PDU | |
| | | | session | |
| | | | This IE may | |
| | | | be present in | |
| | | | case of | |
| | | | changing of | |
| | | | Non-GBR | |
| | | | QoS flows and | |
| | | | is ignored | |
| | | | otherwise. | |

TABLE 2

| | | | IE type | |
|---|---|---|---|---|
| | | | and | |
| IE/Group Name | Presence | Range | reference | Semantics description |
| 5QI | M | | INTEGER | Indicating standardized or pre- |
| | | | (0 . . . 255, . . . ) | configured 5QI |
| Priority Level | O | | 9.3.1.84 | Priority may be a standard technical |
| | | | | standard in (TS) 23.501 [9]. Priority |
| | | | | may involve standardized value and |
| | | | | pre-configured value. |
| Averaging | O | | 9.3.1.82 | Averaging Window is specified in TS |
| Window | | | | 23.501 [9]. When included, it |
| | | | | overrides value pre-specified by |
| | | | | protocol. |
| Maximum Data | O | | 9.3.1.83 | Maximum Data Burst Volume is |
| Burst Volume | | | | specified in TS 23.501 [9]. It involves |
| | | | | standardized value and pre-configured |
| | | | | value. |

TABLE 3

| | | | IE type | |
|---|---|---|---|---|
| | | | and | |
| IE/Group Name | Presence | Range | reference | Semantics description |
| Priority Level | M | | 9.3.1.84 | Priority Level is specified in TS |
| | | | | 23.501 |
| Packet Delay | M | | 9.3.1.80 | Packet Delay Budget is specified in |
| Budget | | | | TS 23.501 [9] |
| Packet Error Rate | M | | 9.3.1.81 | Packet Error Rate is specified in TS |
| | | | | 23.501 |
| 5QI | O | | INTEGER | The dynamically assigned 5QI is |
| | | | (0 . . . 255, . . . ) | specified in TS 23.501 |
| Delay Critical | C- | | ENUMERATED | Averaging Window is specified in |
| | ifGBRflow | | (delay critical, | 23.501. When included, it is to |
| | | | non-delay | override value pre-specified by |
| | | | critical, . . . ) | protocol. |
| Averaging | C- | | 9.3.1.82 | Averaging Window is specified in TS |
| Window | ifGBRflow | | | 23.501 [9]. |
| Maximum Data | O | | 9.3.1.83 | Maximum Data Burst Volume is |
| Burst Volume | | | | specified in TS 23.501 [9]. This IE |
| | | | | shall include delay critical value if the |
| | | | | Delay Critical IE is set to “delay |
| | | | | critical” and is ignored otherwise. |

It is to be noted that any QoS parameter shown in Table 1 to Table 3 may be used alone or in combination with other QoS parameters.

The collaborative parameter configuration is adopted by the device to collaboratively schedule a plurality of QoS flows. The scenario corresponding to the collaborative scheduling of the plurality of QoS flows is the collaborative scheduling scenario. The plurality of QoS flows that are scheduled collaboratively are usually related. For example, they are training data interacting between any two different devices in a joint learning scenario.

The non-collaborative parameter configuration is adopted for the device to perform independent scheduling of a single QoS flow under trigger conditions corresponding to different trigger events. For example, another set of QoS scheduling parameters is switched to once a certain QoS indicator cannot reach a threshold.

In an example, the candidate configuration set includes the plurality of parameter configurations, in which the candidate configuration set includes a reference parameter configuration and one or more difference configurations, and the one or more difference configurations indicate differences of the reference parameter configuration relative to one or more non-reference parameter configurations in the plurality of parameter configurations, respectively.

Alternatively, the candidate configuration set includes the plurality of parameter configurations, in which the candidate configuration set includes a reference parameter configuration and one or more conversion relationship configurations, and the one or more conversion relationship configurations indicate conversion relationships between the reference parameter configuration and one or more non-reference parameter configurations in the plurality of parameter configurations, respectively.

The reference parameter configuration here may be any specified parameter configuration. For example, the reference parameter configuration may be a parameter configuration under a preset circumstance where the QoS flow is in the independent scheduling scenario. Other non-reference parameter configurations may be any parameter configurations different from the reference parameter configuration.

As an example, one reference parameter configuration refers to the QoS parameter when multi-modal services are not carried, that is, when there is no multi-flow collaborative scheduling requirement.

As an example, if the candidate configuration set includes one non-collaborative parameter configuration and at least one collaborative parameter configuration, the non-collaborative parameter configuration may be selected as the foregoing reference parameter configuration, and all other collaborative parameter configurations may be selected as the difference configurations.

As an example, two or more QoS flows, when not being scheduled collaboratively, adopt their own QoS parameters, e.g., Parameter Configuration 1 and Parameter Configuration 2, respectively. However, they adopt their own collaborative scheduling parameter configurations in the collaborative scheduling scenario, i.e., Parameter Configuration 1′ and Parameter Configuration 2′, respectively. In this case, for QoS Flow 1, its candidate configuration set includes the plurality of parameter configurations, i.e., Parameter Configuration 1 and Parameter Configuration 1′. Parameter Configuration 1 is the reference parameter configuration, and Parameter configuration 1′ may be determined based on the difference configure and the reference parameter configuration jointly. For example, if a packet delay defined by Parameter Configuration 1 is estimated to be 100 ms and the difference configuration indicates-50 ms, the packet delay of Parameter Configuration 2 is obtained to be 50 ms based on Parameter Configuration 1 and the difference configuration. For QoS flow 2, the candidate configuration set includes the plurality of parameter configurations, i.e., Parameter Configuration 2 and Parameter Configuration 2′. In this case, Parameter Configuration 2′ is determined by combining Parameter Configuration 2 and the difference configuration.

As an example, if the candidate configuration set includes the plurality of non-collaborative parameter configurations, one collaborative parameter configuration may be selected as the foregoing reference parameter configuration, and the others may be selected as the difference configurations.

As an example, there may also be the plurality of candidate configurations for the QoS flow in the independent scheduling scenario, Parameter Configuration 1 and Parameter Configuration 2. Parameter Configuration 2 is adopted when the network detects an abnormality, and Parameter Configuration 1 is adopted in other conditions. In this case, Parameter Configuration 1 is the reference parameter configuration, and reference Parameter Configuration 2 is the difference configuration.

As an example, if the candidate configuration set includes one non-collaborative parameter configuration and at least one collaborative parameter configuration, the non-collaborative parameter configuration may be selected as the foregoing reference parameter configuration, and all of the other collaborative parameter configurations may be taken as the difference configurations.

As another example, if the candidate configuration set includes one collaborative parameter configuration and at least one non-collaborative parameter configuration, the collaborative parameter configuration may be selected as the reference parameter configuration, and all of the other parameter configurations are the difference configurations. Alternatively, one non-collaborative parameter configuration with a minimum QoS value is selected as the reference parameter configuration, and all of the other parameter configurations are the difference configurations.

As an example, firstly, the reference parameter configuration is one parameter configuration in the candidate configuration set.

During its specific implementation, the reference parameter configuration is selected from the plurality of parameter configurations in the candidate configuration set.

The reference parameter configuration may be at least one of the plurality of parameter configures as follows: the parameter configuration including the minimum packet delay estimation; the parameter configuration including maximum packet delay estimation; any one parameter configuration appointed by a second network device; or a parameter configuration agreed in a protocol.

The candidate configuration set includes the plurality of parameter configurations, in which the candidate configuration set includes a reference parameter configuration and one or more difference configurations, and the one or more difference configurations indicate differences of the one or more non-reference parameter configurations in the plurality of parameter configurations relative to the reference parameter configuration, respectively.

Alternatively, the candidate configuration set includes the plurality of parameter configurations, in which the candidate configuration set includes a reference parameter configuration and one or more conversion relationship configurations, and the one or more conversion relationship configurations indicate conversion relationships between the non-reference parameter configurations in the plurality of parameter configurations and the reference parameter configuration, respectively.

Both the collaborative parameter configuration and the non-collaborative parameter configuration are used for assigning values to the QoS parameters of the QoS flow.

Therefore, the foregoing difference may be obtained by making a difference between the same QoS parameter of different parameter configurations. Compared with one or more bits for indicating the parameter value of an initial QoS parameter, only the difference value is required to be indicated, which may reduce the bit overhead.

The difference configuration may include but is not limited to directly indicating the difference value.

Similarly, the parameter value between the same QoS parameter of different parameter configurations may be converted based on a conversion relationship. Therefore, compared with completely carrying the parameter values of all the QoS parameters of each parameter configuration, it has the feature of small bit overhead through carrying and indicating the conversion relationship by one or more bits.

The conversion relationship configuration may include but is not limited to one or more direct conversion relationship indicators.

In some examples, the conversion relationships between the non-collaborative parameter configuration and the collaborative parameter configuration indicate at least one of the following: ratios between one or more parameters of the reference parameter configuration and the same parameters of the non-reference parameter configuration; differences between one or more parameters of the reference parameter configuration and the same parameters of the non-reference parameter configuration; or conversion functions between one or more parameters of the reference parameter configuration and the same parameters of the non-reference parameter configuration.

As an example, the packet delay budget of the QoS flow in the collaborative scheduling scenario is a ratio of the packet delay budget in the independent scheduling scenario, such as 1/2 or 1/3.

As another example, the packet delay budget of the QoS flow in the collaborative scheduling scenario is a difference value from that in the independent scheduling scenario, such as 10 ms, 20 ms or 50 ms.

The conversion function may be a conversion function composed of any four fundamental operations of arithmetic or another conversion function. For example, in some cases, when determining the conversion relationship between the collaborative parameter configuration and the non-collaborative parameter configuration for the plurality of QoS parameters, either the ratio or the difference cannot adequately reflect the conversion relationship between the two. It may be expected to fit the conversion relationship between the two in a function fitting manner. The conversion function may be a polynomial function or another function.

In some examples, the plurality of QOS flows scheduled collaboratively may include at least one of the following: different QoS flows corresponding to different multi-modal input devices in one multi-modal input scenario; different QoS flows corresponding to different multi-modal output devices in one multi-modal output scenario; or the QoS flows corresponding to different learning devices in a Federated Learning scenario.

If the collaborative parameter configuration takes effect, the base station collaboratively schedules the plurality of QOS flows. Therefore, there is a collaboration when the base station allocates and schedules the resources for the plurality of QOS flows that are related. Such the collaboration is reflected in any of the following aspects: allocating wireless resources to the plurality of QoS flows at the same time; releasing wireless resources allocated for the plurality of QoS flows at the same time; or adjusting the number of resources allocated for the plurality of QoS flows at the same time. The adjustment of the number of resources here includes: increasing the number of resources and/or decreasing the number of resources.

Of course, the above are just some examples that the plurality of QoS flows are collaboratively allocated and scheduled, which is not a limitation of specific implementation.

In the disclosed examples, the first network device determines the collaborative parameter configuration for the plurality of QoS flows, and then the plurality of QoS flows expected to be collaboratively scheduled are collaboratively scheduled, so that it improves the out-of-sync scheduling problem caused by independent scheduling of the plurality of QoS flows expected to be collaboratively scheduled, the resource waste caused by the out-of-sync problem, or a phenomenon of poor service quality caused together with the resource waste.

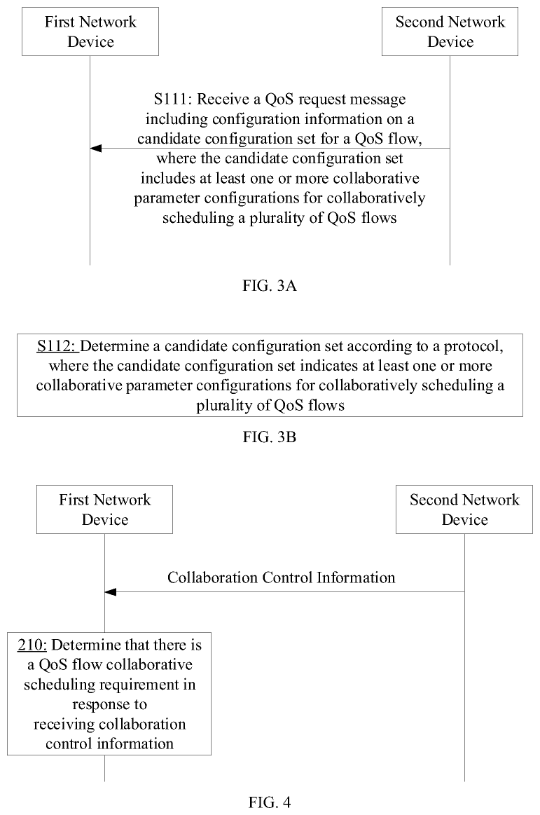

As illustrated in FIG. 3A, an example of the present disclosure provides a QoS flow scheduling method, which is performed by the first network device. The method may include step S111.

At S111, a QoS request message including configuration information on a candidate configuration set for a QoS flow is received.

The candidate configuration set at least includes at least two parameter configurations for the QoS flow.

As an example, the candidate configuration set includes a plurality of parameter configurations from the following parameter configurations: collaborative parameter configurations adopted for collaboratively scheduling this QoS flow and one or more other QoS flows; and non-collaborative parameter configurations adopted for independently scheduling this QoS flow.

In an example of the present disclosure, an access network device such as a base station receives the QoS request message from a core network device. The QoS request message includes configuration information on the candidate configuration set for the QoS flow.

For example, QoS Flow A and QoS Flow B are two QoS flows in one collaborative scheduling scenario. If the first network device receives the QoS request message that is transmitted for QoS Flow A, the candidate configuration set indicated by the QoS request message includes the collaborative parameter configuration for being collaboratively scheduled with QoS Flow B. In this case, after the first network device receives the QoS request message and when QoS Flow A and QoS Flow B are expected to be collaboratively scheduled, the first network device may adopt the collaborative parameter configuration in the candidate configuration set indicated by the QoS request message for QoS Flow A to schedule QoS Flow A.

As illustrated in FIG. 3B, an example of the present disclosure, provides a QoS flow scheduling method, which is performed by the first network device. The method may include step S112.

At S112, a candidate configuration set is determined according to a protocol.

The protocol here includes an industry-recognized and standardized standard protocol, and/or a private protocol jointly customized by multiple manufacturers or vendors.

If the protocol specifies the candidate configuration set for multi-QoS-flow scheduling, the first network device may learn the candidate configuration set for the QoS flow by querying the protocol, and obtain the one or more collaborative parameter configurations based on the determined candidate configuration set.

As an example, the candidate configuration set may be a set including only one or more collaborative parameter configurations. Thus, the core network and/or the protocol specify only the collaborative parameter configurations for the QoS flow. As another example, the candidate configuration set may also include one or more non-collaborative parameter configurations other than the collaborative parameter configurations. The non-collaborative parameter configurations may be called independent parameter configurations, and may be adopted for independently scheduling the corresponding QoS flow.

In some examples, the candidate configuration set also indicates the one or more non-collaborative parameter configurations for independently scheduling the QoS flow.

In the case where the requirement for collaboratively scheduling QoS Flow A and QoS Flow B disappears, but QoS Flow A is still being transmitted, the non-collaborative parameter configuration for QoS Flow A may be adopted to schedule QoS Flow A independently.

As an example, in a video record circumstance of multiple video record devices where the QoSs of different video record devices are transmitted separately, these QoS flows may be expected to be collaboratively scheduled. For example, by collaboratively scheduling the collaborative transmissions of the QoS flows, it ensures no much difference between the delays that the data flows transmitted from multiple video record devices reach a receiver, thereby producing fewer phenomena that the picture received by the receiver always lacks a part due to the big arrival delay of the data flow from a certain video record device. In some scenarios, if the picture recorded by the certain video record device is cut out, the data flow of Video Record Device A is not expected to continue to be collaboratively scheduled with other video record devices. In such scenario, it restores to independently schedule Video Record Device A. In the independent scheduling scenario, the resources allocated for Video Record Device A may be released or reduced, etc. Of course, the above is only an example, which is not a limit to the specific implementation.

In an example, the candidate configuration set indicates the one or more collaborative parameter configurations and the one or more non-collaborative parameter configurations, in which the candidate configuration set includes a non-collaborative parameter configuration and one or more first difference configurations, and the one or more first difference configurations indicate the difference configurations of the collaborative parameter configurations relative to the one or more non-collaborative parameter configurations, respectively.

Alternatively, the candidate configuration set indicates the one or more collaborative parameter configurations and the one or more non-collaborative parameter configurations, in which the candidate configuration set includes a collaborative parameter configuration and one or more second difference parameter configurations, and the one or more second difference configurations include the difference configurations of the one or more non-collaborative parameter configurations relative to the collaborative parameter configuration, respectively.

In some cases, the values of some QoS parameters of the collaborative parameter configuration are the same as those of the non-collaborative parameter configuration, respectively. Compared with configuring two kinds of complete configurations, the collaborative parameter configurations and the non-collaborative parameter configurations, the QoS configurations are reduced if only the first difference configurations or the second difference configurations are included, which may reduce the bit overhead.

In some other cases, the value of each QoS parameter in the collaborative parameter configurations may be different from the value of the QoS parameter in the non-collaborative parameter configuration. By taking one value as a reference value to calculate the difference between the two, it may use fewer bits to provide the indicators since the differences are smaller than the QoS parameters as the minuend, which can reduce the bit overhead.

Therefore, it may reduce the bit overhead in this way, and is especially suitable for the case where the core network issues the candidate configuration set to the access network.

In some examples, the candidate configuration set indicates the one or more collaborative parameter configurations and the one or more non-collaborative parameter configurations, in which the candidate configuration set includes a non-collaborative parameter configuration and one or more first conversion identifiers, and the first conversion identifiers indicate the conversion relationships between the non-collaborative parameter configuration and the one or more collaborative parameter configurations, respectively.

Alternatively, the candidate configuration set indicates the one or more collaborative parameter configurations and the one or more non-collaborative parameter configurations, in which the candidate configuration set includes a collaborative parameter configuration and one or more second conversion identifiers, and the second conversion identifiers indicate the conversion relationships between the one or more non-collaborative parameter configurations and the collaborative parameter configuration, respectively.

In some examples, the first conversion identifiers and the second conversion identifiers indicate the conversion relationships.

As an example, the bandwidth in the independent scheduling scenario and the bandwidth in the collaborative scheduling scenario may satisfy one or more conversion relationships. Which conversion relationship is currently adopted may be determined by the first conversion identifier or the second conversion identifier carried by the candidate configuration set. By indicating the one or more collaborative parameter configurations and the one or more non-collaborative parameter configurations in this way, it has a feature of fewer bit overhead, and is especially suitable for such a scenario where the configuration information on the candidate configuration set is expected to be transmitted between different network devices.

In some examples, the conversion relationships between the non-collaborative parameter configuration and the collaborative parameter configuration indicate at least one of the following: ratios between one or more parameters of the non-collaborative parameter configuration and the same parameters of the collaborative parameter configuration; differences between one or more parameters of the non-collaborative parameter configuration and the same parameters of the collaborative parameter configuration; or conversion functions between one or more parameters of the non-collaborative parameter configuration and the same parameters of the collaborative parameter configuration.

As an example, the packet delay budget of the QoS flow in the collaborative scheduling scenario is a ratio of the packet delay budget in the independent scheduling scenario, such as 1/2 or 1/3.

As another example, the packet delay budget of the QoS flow in the collaborative scheduling scenario is a difference relative to the packet delay budget in the independent scheduling scenario, such that 10 ms, 20 ms or 50 ms.

The foregoing different ratios or different differences may correspond to different first conversion identifiers and/or second conversion identifiers.

Different from the first difference configurations and the second difference configurations in the previous example, the differences indicated by the first conversion identifiers and/or the second conversion identifiers may not be the differences themselves. For example, the first conversion identifiers and the second conversion identifiers may be difference indexes or difference serial numbers, etc.

In some other examples, the first conversion identifiers and the second conversion identifiers may be at least different conversion relationships in a conversion table. The conversion relationships between the collaborative parameter configuration and the non-collaborative parameter configuration may be learned by searching the table.

In some examples, the QoS request message includes at least one of the following: a QoS setup request message; or a QoS modify request message.

The configuration information on the candidate configuration set is directly carried in the QoS setup request message so that during the establishment of the corresponding QoS flow, the first network device learns the candidate configuration set for the QoS flow.

When the network state and/or the state of the UE participating in the communication change, there may be a requirement for modifying the QoS flow. In this case, the first network device is to receive the QoS modify request message by which the configuration information on the candidate configuration set is carried. Therefore, the first network device may simultaneously learn the one or more collaborative parameter configurations for the modified QoS flow while modifying the QoS flow.

In sum, no matter which scheme is employed when the first network device obtains the configuration information on the candidate configuration set by receiving the QoS request message, it can on one hand achieve obtaining the configuration information on the candidate configuration set that includes at least the collaborative parameter configuration without introducing any new message, and it can achieve on the other hand obtaining the configuration information in the QoS flow scheduling scenario at the beginning that the QoS flow is established or modified, which covers most scenarios where one or more collaborative parameter configurations are expected to be obtained, and has the features of easy realization and wide coverage.

The QoS setup request message includes but is not limited to a protocol data unit (PDU) session resource setup request and/or an initial context setup request.

The QoS modify request message includes but is not limited to a PDU session resource modify request.

In some examples, the method further includes: in response to determining a QoS flow collaborative scheduling requirement, collaboratively scheduling at least two QoS flows according to a collaborative parameter configuration.

Only when there is the collaborative scheduling requirement, the collaborative scheduling of at least two QoS flows is performed. Without the collaborative scheduling requirement, it may independently schedule the single flow, instead of performing the collaborative QoS flow scheduling according to the collaborative parameter configuration.

When determining that there is an association relationship between a plurality of QoS flows, the first network device may determine by itself that there is the collaborative scheduling requirement for the QoS flows. For example, when receiving resource scheduling requests from multiple UE located in the same UE group, the first network device may determine that there is the association relationship between different QoS flows corresponding to the multiple UE. Of course, this is only an example for illustrating the way in which the first network device determines by itself whether there is the collaborative scheduling requirement for the plurality of QoS flows, which is not a limit to the specific implementation.

In response to a change in the collaborative scheduling scenario, the collaborative parameter configuration for the collaborative scheduling is replaced by another collaborative parameter configuration.

In at least one of the above conditions, it means that the collaborative scheduling scenario changes.

If the above condition occurs, the second network device may transmit collaboration control information, and the collaboration control information triggers the first device to switch to another collaborative parameter configuration for collaboratively scheduling the plurality of QoS flows.

Any one of the above conditions may correspond to a trigger event and the event identifier of the trigger event may be carried in the collaboration control information. In this way, when receiving the collaboration control information, the first network device also learns the trigger event that currently causes the transmission of the collaboration control information. Further, based on the trigger event, the first network device may select the collaborative parameter configuration which is adopted after the switching.

That is, in an example, the collaboration control information may also indicate the trigger event that requires the collaborative parameter configuration for collaboratively scheduling the plurality of QoS flows.

As an example, without being collaboratively scheduled, two or more QoS flows adopt their own QoS parameters, e.g., Parameter Configuration 1 and Parameter Configuration 2. However, in the collaborative scheduling scenario, QoS Flow 1 cannot meet the requirements, that is, it may be considered that the trigger event is detected, and the two QoS to be collaborated adopt their candidate parameter configurations for the collaborative scheduling, Parameter Configuration 1′ and Parameter Configuration 2′, respectively. In this case, for QOS Flow 1, the candidate configuration set includes a plurality of parameter configurations, i.e., Parameter Configuration 1 and Parameter Configuration 1′; and for QoS Flow 2, the candidate configuration set includes a plurality of parameter configurations, i.e., Parameter Configuration 2 and Parameter Configuration 2′.

In some examples, the method further includes: in response to a change in the independent scheduling scenario, adjusting the parameter configuration being adopted for independently scheduling the QoS flow according to the one or more non-collaborative parameter configurations.

For example, when at least one of the network state, the UE state and/or service subscription changes, it may be considered that the independent scheduling scenario has changed. In the example of the present disclosure, the parameter configuration adopted for independently scheduling the QoS flow is to be adaptively adjusted.

As an example, the method further includes: in response to receiving a notification on a triggering event, determining the change in the independent scheduling scenario.

The change in the foregoing independent scheduling scenario may be configured as the trigger condition corresponding to the trigger event. The first network device, the second network device and/or the UE may detect whether the trigger event occurs. If detecting the occurrence of the trigger event by itself, the first network device itself may switch the parameter configuration for the independent scheduling. If the second network device or the UE detects that the trigger event occurs, the first network device is to receive the notification, so that the first network device can adopt the parameter configure for independently scheduling the QoS flows according to the notification.

In an example, the change in the independent scheduling scenario may include at least one of the following: in response to the QoS value of the QoS flow falling below a QoS threshold, determining that the independent scheduling scenario with the QoS flow has changed; in response to the modified QoS value of the QoS flow reaching the QoS threshold, determining that the independent scheduling scenario with the QoS flow has changed; or in response to a resource allocation failure for the QoS flow, determining that the independent scheduling scenario with the QoS flow has changed.

In some examples, if the notification comes from the second network device, the notification is carried in a service request message.

As an example, the service request message includes at least one of the following: a service setup request message; or a service modify request message.

In some examples, the notification further indicates one or more QoS flows whose independent scheduling scenarios change.

In some examples, the method further includes: in response to receiving a notification that an independent scheduling scenario is restored, restoring to initial parameter configuration for independently scheduling the QoS flow.

Since the independent scheduling scenario is restored, it may adaptively restore to the initial parameter configuration that is adopted before the parameter configuration for the QoS flow is switched.

In some examples, if the candidate configuration set includes a plurality of non-collaborative parameter configurations, one default parameter configuration or one specified parameter configurations may be taken as the initial parameter configuration, that is, the parameter configuration adopted for the initial setup of the QoS flow is the initial parameter configuration. Subsequently, based on whether the trigger event is met, it is to switch among the plurality of parameter configurations in the candidate configuration set for being adopted.

As illustrated in FIG. 4, an example of the present disclosure provides a QoS flow scheduling method, which is performed by the first network device. The method may include step S210.

At S210, it is determined that there is a QoS flow collaborative scheduling requirement in response to receiving collaboration control information.

The collaboration control information may come from but not limited to a second network device that issues a QoS request message.

When scheduling resources for a plurality of QOS flows with a collaborative scheduling requirement, the first network device performs a collaborative scheduling according to the collaborative parameter configurations for the QoS flows.

The specific collaborative scheduling schemes may be referenced by the foregoing examples, or may be collaborative scheduling schemes other than those provided in the foregoing examples.

In sum, this example may be performed alone or in combination with the foregoing S110, etc.

After receiving the collaboration control information, it is determined that there is the collaborative scheduling requirement for the QoS flows. Therefore, after the corresponding QoS flows are initiated, it performs the collaborative scheduling of the plurality of QoS flows or switches the collaborative scheduling parameters for the plurality of QoS flows that are being collaboratively scheduled.

For example, the core network device indicates through the collaboration control information that there is the collaborative scheduling requirement for the plurality of QoS flows.

In an example, the collaboration control information may indicate a starting of the collaborative scheduling, so that the first network device starts the collaborative scheduling of the plurality of QoS flows after receiving it. In another example, the collaboration control information may further include: event information on the trigger event that triggers the transmission of the collaboration control information, or the collaboration control information may also indicate determination information used for determining the collaborative parameter configuration adopted in the collaborative scheduling. The determination information includes but is not limited to the above event information on the trigger events that have a corresponding relationship with different collaborative parameter configurations, and may also include a configuration identifier of the collaborative parameter configuration, etc.

In some examples, receiving the collaboration control information includes: receiving a service request message including the collaboration control information.

The collaboration control information mentioned in the foregoing examples may be carried in any message and be transmitted between the first network device and another network device (for example, the second network device). In this example of the present disclosure, it may be carried in the service request message.

By carrying the collaboration control information in the service request message, it may make the first network device informed of whether the QoS flows corresponding to the service have a collaborative scheduling requirement at the same time of requesting the service and/or modifying the service.

As an example, the service request message includes at least one of the following: a service setup request message; or a service modify request message.

In some examples, the collaboration control information further indicates the QoS flows to be collaboratively scheduled.

In an example, the QoS flows to be collaboratively scheduled and the collaborative scheduling requirement may be indicated by one field. For example, it is the first field. The first field may include service identifiers, flow identifiers of the QoS flows, and/or a group identifier of a UE group. It is greatly possible that different QoS flows corresponding to multiple UE in the same UE group have the requirement for being collaboratively scheduled. If this field indicates the group identifier, it may be considered that the QoS flows of the multiple UE in the group corresponding to the group identifier require to be collaboratively scheduled.

For example, when the collaboration control information includes the flow identifiers or the service identifiers of the plurality of QoS flows, based on the flow identifiers, the service identifiers or the group identifier, it may learn which QoS flows require to be collaboratively scheduled, and meanwhile, it is equivalent to indicating the current requirement for multi-QoS-flow collaborative scheduling.

For another example, a service setup request message of Service A carries the service identifier, flow identifier or group identifier of Service B. In this case, the service identifier, the flow identifier or the group identifier is equivalent to indicating the QoS flow to be collaboratively scheduled with the QoS flow of Service A, and is equivalent to indicating the existence of the requirement for the collaborative scheduling between the QoS flow of Service A and the QoS flow of Service B.

In another example, the multi-QoS-flow collaborative scheduling requirement and the QoS flows that require to be collaboratively scheduled may be indicated by different fields. For example, Field A may include one or more bits for indicating whether there is a collaborative scheduling requirement, and Field B indicates the flow identifiers, the service identifiers and/or a group identifier of the UE group corresponding to the QoS flows that require to be collaboratively scheduled.

In some examples, the first network device does not receive the collaboration control information that is explicitly indicated. Instead, the collaboration control information is implicitly indicated.

For example, the second network device assigns the plurality of QoS flows that are required to be collaboratively scheduled into one QoS flow group. The grouping information on the QoS flow group may be considered as the information that implicitly indicates the requirements for collaboratively scheduling the plurality of QoS flows.

Therefore, in some examples, the collaboration control information is determined based on the grouping information of the plurality of QoS flows.

For example, when the second network device determines the requirement for collaboratively scheduling the plurality of QoS flows, the first network device is to receive the grouping information on the plurality of QoS flows that is transmitted by the second network device. The grouping information may be the group identifier or the service identifiers of the plurality of grouped QoS flows. The grouping information indicates the plurality of QoS flows that require to be collaboratively scheduled, and is also equivalent to indicating the multi-QoS-flow collaborative scheduling requirement.

In an example, the method further includes: in response to receiving non-collaboration control information, restoring to independently schedule at least two QoS flows that are being collaboratively scheduled.

Here, the non-collaboration control information may also be called independent control information.

In a case where the plurality of QoS flows are currently in the collaborative scheduling scenario, the non-collaboration control information is equivalent to indicating that the corresponding QoS flows leave the collaborative scheduling of the plurality of QoS flows and restore to independent scheduling.

In a case where the plurality of QoS flows are currently in the non-collaborative scheduling scenario, the non-collaboration control information is equivalent to indicating that the corresponding QoS flows maintain their independent scheduling.

As illustrated in FIG. 5, an example of the present disclosure provides a QoS flow scheduling method, which is performed by a second network device. The method may include step S310.

At S310, a QoS request message is transmitted, where the QoS request message indicate a candidate configuration set for a QoS flow and the candidate configuration set includes a plurality of parameter configurations for the QoS flow.

As an example, the candidate configuration set includes at least one of: one or more collaborative parameter configurations, which are one or more parameter configurations for multi-QoS-flow collaborative scheduling; or one or more non-collaborative parameter configurations, which are one or more parameter configurations for independently scheduling the QoS flow.

The candidate parameter configuration set here may include one or more non-collaborative parameter configurations. Similarly, the candidate configuration set may include one or more collaborative parameter configurations.

As an example, the one or more non-collaborative parameter configurations include a plurality of parameter configurations for independently scheduling the QoS flow in different scenarios.

In some examples, the second network device may be the network device in a core network, referred to as a core network device.

The second network device includes but is not limited to an access and mobility management function (AMF), a session management function (SMF), a user plane function (UPF) and another network device.

The QoS request message indicating the candidate configuration set for the QoS flow includes but is not limited to: the QoS request message including configuration information that explicitly indicates the candidate configuration set; and/or the QoS request message including information that corresponds to the candidate configuration set and also indicates other contents. This indication way is equivalent to an implicit indication.

The candidate configuration set includes the plurality of parameter configurations, in which the candidate configuration set includes a reference parameter configuration and one or more difference configurations, and the one or more difference configurations indicate differences of one or more non-reference parameter configurations in the plurality of parameter configurations relative to the reference parameter configuration, respectively.

Alternatively, the candidate configuration set includes the plurality of parameter configurations, in which the candidate configuration set includes a reference parameter configuration and one or more conversion relationship configurations, and the one or more conversion relationship configurations indicate conversion relationships between the reference parameter configuration and one or more non-reference parameter configurations in the plurality of parameter configurations, respectively.

In one example, the conversion relationships between one or more parameters of the reference parameter configuration and the same parameters of the non-reference parameter configuration indicates at least one of the following: ratios between the one or more parameters of the reference parameter configuration and the same parameters of the non-reference parameter configuration; differences between the one or more parameters of the reference parameter configuration and the same parameters of the non-reference parameter configuration; or conversion functions between the one or more parameters of the reference parameter configuration and the same parameters of the non-reference parameter configuration.

For example, the candidate configuration set indicates the one or more collaborative parameter configurations and the one or more non-collaborative parameter configurations, in which the candidate configuration set includes a non-collaborative parameter configuration and one or more first difference configurations, and the one or more first difference configurations indicate the difference configurations of the one or more collaborative parameter configurations relative to the non-collaborative parameter configuration, respectively.

Alternatively, the candidate configuration set indicates the one or more collaborative parameter configurations and the one or more non-collaborative parameter configurations, in which the candidate configuration set includes a collaborative parameter configuration and one or more second difference parameter configurations, and the one or more second difference configurations include the difference configurations of the one or more non-collaborative parameter configurations relative to the collaborative parameter configuration, respectively.

The descriptions of the first difference configurations and the second difference configurations here may be referenced by the foregoing examples, which are not repeated here. If the candidate configuration set including both the one or more collaborative parameter configurations and the one or more non-collaborative parameter configurations is indicated by the second network device, by using the first difference configurations and the second difference configurations to implement indicating the two kinds of parameter configurations, it can reduce the bit overhead and shorten the length of signaling interacted between the first network device and the second network device.

For another example, the candidate configuration set indicates the one or more collaborative parameter configurations and the one or more non-collaborative parameter configurations, in which the candidate configuration set includes a non-collaborative parameter configuration and one or more first conversion identifiers, and the one or more first conversion identifiers indicate the conversion relationships between the non-collaborative parameter configuration and the one or more collaborative parameter configurations, respectively.

Alternatively, the candidate configuration set indicates the one or more collaborative parameter configurations and the one or more non-collaborative parameter configurations, in which the candidate configuration set includes a collaborative parameter configuration and one or more second conversion identifiers, and the second conversion identifiers indicate the conversion relationships between the one or more non-collaborative parameter configurations and the collaborative parameter configuration, respectively.

The first conversion identifier and/or the second conversion identifier both indicate the conversion relationship between the collaborative parameter configuration and the non-collaborative parameter configuration. For example, in the example of the present disclosure, the first conversion identifier and the second conversion identifier may both be an index or a serial number corresponding to the conversion relationship. Therefore, after receiving the configuration information on the candidate configuration set, the first network device first determines one configuration from the one or more collaborative parameter configurations and the one or more non-collaborative parameter configurations in the candidate configuration set, then finds a conversion relationship based on the first conversion identifier or the second conversion identifier, and inputs the determined parameter configuration into the conversion relationship as a known volume to obtain another parameter configuration. The configuration information only contains a conversion identifier, which has the feature of small bit overhead compared to carrying the whole parameter value of the parameter configuration.

As an example, the conversion relationships between the non-collaborative parameter configuration and the collaborative parameter configuration indicate at least one of the following: ratios between one or more parameters of the non-collaborative parameter configuration and the same parameters of the collaborative parameter configuration; differences between one or more parameters of the non-collaborative parameter configuration and the same parameters of the collaborative parameter configuration; or conversion functions between one or more parameters of the non-collaborative parameter configuration and the same parameters of the collaborative parameter configuration.

In some examples, the QoS request message includes at least one of the following: a QoS setup request message; or a QoS modify request message.

As an example, the QoS setup request message includes but is not limited to a PDU session resource setup request and/or an initial context setup request.

The QoS modify request message includes but is not limited to a PDU session resource modify request.

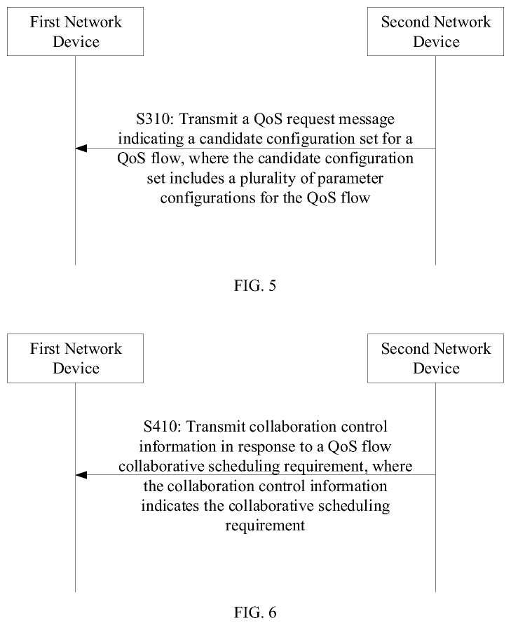

As illustrated in FIG. 6, an example of the present disclosure provides a QoS flow scheduling method, which is performed by the second network device. The QoS flow scheduling method may include step S410.

At S410, collaboration control information is transmitted in response to a QoS flow collaborative scheduling requirement, where the collaboration control information indicates the collaborative scheduling requirement.

In this example of the present disclosure, the second network device issues the collaboration control information. The collaboration control information may trigger a first network device to collaborative schedule a plurality of QoS flows.

After receiving the collaborative scheduling requirement, the first network device may collaboratively schedule the plurality of QoS flows according to a collaborative parameter configuration transmitted by the second network device, or may collaboratively schedule the plurality of QoS flows according to the collaborative parameter configuration determined by the first network device in another way (e.g., based on a protocol).

In sum, the QoS flow scheduling method provided by the example of the present disclosure may be performed alone or in combination with the foregoing other QoS flow scheduling methods applied to the second network device.

In an example, transmitting the collaboration control information includes: transmitting a service request message including the collaboration control information.

In an example of the present disclosure, the collaboration control information is included in a service request message, so that no dedicated signaling is involved to transmit the collaboration control information. Meanwhile, the collaboration control information is transmitted once a service request or a service modification occurs. Therefore, it achieves the features of implementing multiple functions by one message and reducing the amount of information interaction between the first network device and the second network device.

In some examples, the method further includes monitoring the QOS values of the plurality of QoS flows with an associated relationship.

Monitoring the QoS values of the plurality of QoS flows here may include: monitoring the QoS values of the QoS parameters such as an actual delay, an allocated bandwidth, and/or a packet loss rate. For example, monitoring the QoS values of the plurality of QoS flows here may include: monitoring the QoS values of the plurality of QoS flows by the first network device itself, or receiving the QoS values of the QoS flows monitored by the UE from the UE.

In some examples, the method may include: determining, based on the monitored QoS values, whether there is a multi-QoS-flow collaborative scheduling requirement.

Of course, for determining whether there is the multi-QoS-flow collaborative scheduling requirement, it may also be determined based on a resource allocation result at the beginning of the setup of the plurality of QoS flows.

As an example, the method may include: in response to a QOS value of at least one of the plurality of QoS flows being lower than a QoS threshold, determining that there is the QoS flow collaborative scheduling requirement; in response to the QoS value of each of the plurality of QoS flows reaching the QoS threshold after the QoS value of at least one of the plurality of QoS flows changes, determining that there is the QoS flow collaborative scheduling requirement; in response to a resource allocation failure for at least one of the plurality of QoS flows, determining that there is the QoS flow collaborative scheduling requirement; or in response to a resource allocation failure for each of the plurality of QoS flows, determining that there is the QoS flow collaborative scheduling requirement.

It is noted that for the response to the QOS value of at least one of the plurality of QoS flows being lower than the QoS threshold, the response to the QoS value of any one of the plurality of QoS flows reaching the QoS threshold after the QoS value of at least one of the plurality of QoS flows changes, the response to the resource allocation failure for at least one of the plurality of QoS flows, and the response to the resource allocation failure for each of the plurality of QoS flows, each of those may be considered to correspond to one trigger event. Once the trigger event occurs, it is determined that there is the collaborative scheduling requirement, and the collaboration control information is transmitted to the first network device.

The QoS values of one or more QoS parameters, such as the actual bandwidth, the bit error rate, and the packet loss rate of the plurality of QOS flows with the association relationship are monitored. When it is monitored that the QoS value of at least one QoS flow is lower than the QoS threshold, the QoS value of this QoS flow degrades the overall quality of the plurality of QoS flows with the association relationship. If other QoS flows are still allocated with a large number of resources, it results in both a waste of resources and a poor communication quality.

When the QoS value of each of the plurality of QOS flows with the association relationship reaches the QoS threshold, it means that the plurality of QOS flows may currently provide users with better communication quality after being combined. In this case, it may be considered that there is the collaborative scheduling requirement. For example, the actual delay of each of the plurality of QoS flows is less than the packet delay budget of the collaborative scheduling. This indicates that the network circumstance presents a higher transmission rate. If continuing to independently schedule various QoS flows according to the large packet delay budget, it cannot effectively utilize the communication resources on one hand and cannot provide high QoS allowed by the current network circumstance on the other hand.

Similarly, during a setup stage of a QoS flow, it may be determined based on a resource allocation result of the plurality of QoS flows whether to maintain the scheduling of the remaining QoS flows, or it is determined to continue to collaboratively schedule resources for the plurality of QoS flows after completing the resource allocation of each QoS flow.

As an example, if the resource allocation for at least one of the plurality of QoS flows with the association relationship fails, the resource allocation failure of the QoS flow causes that the communication service provided by the combination of the plurality of QoS flows cannot be achieved or have extremely poor quality. It may be consider that there is the collaborative scheduling requirement, and then, may trigger the first network device to temporarily release the resources that have been allocated to other QoS flows among the plurality of QoS flows, or to delay the resource allocation for other associated QoS flows. For example, it is to perform the resource allocation for other QoS flows associated with the QoS flow after successfully allocating the resources to the QoS flow.

In some examples, the collaboration control information is further used for indicating the QoS flows to be collaboratively scheduled.

How the collaboration control information indicates the QoS flows to be collaboratively scheduled may be referenced by the corresponding embodiments described above, which is not repeated here.

In some examples, the method further includes: in response to the disappearance of the multi-QoS-flow collaborative scheduling requirement, non-collaboration control information is transmitted. The non-collaboration control information indicates to restore to independently schedule the plurality of QoS flows.

In an example of the present disclosure, if the collaborative scheduling requirement for the plurality of QoS flows disappears, the disappearance of the collaborative scheduling requirement is indicated through the non-collaboration control information. If the plurality QoS flows are still in the collaborative scheduling scenario, the first network device is to restore to independently schedule various QOS flows after receiving the non-collaboration control information. If any one of the plurality of QoS flows has enter the non-collaborative scheduling scenario and is independently scheduled based on another reason, the first network device keeps the independent scheduling of the corresponding QoS flow.

An example of the present disclosure provides a QoS flow scheduling method, which may be performed by the second device. The method further includes: in response to a change in the independent scheduling scenario, transmitting a notification on the change of the independent scheduling scenario.

If it is determined that the independent scheduling scenario changes, the notification indicating that the independent scheduling scenario has changed is transmitted to the first network device, so that the first network device can promptly adjust the parameter configuration adopted for scheduling the single QoS flow according to the scenario's change.

In some examples, the notification includes that a triggering event occurs.

In some examples, the notification is carried in a service request message.

In some examples, the service request message includes at least one of the following: a service setup request message; or a service modify request message.

As an example, the QoS setup request message includes but is not limited to a PDU session resource setup request and/or an initial context setup request.

The QoS modify request message includes but is not limited to PDU session resource modify request.

In some examples, the notification further indicates one or more QoS flows whose independent scheduling scenario changes.

In some examples, the method further includes: transmitting a notification indicating that the independent scheduling scenario is restored.

The notification indicating that the independent scheduling scenario is restored may enable the first network device to restore to the initial parameter configurations or default parameter configurations for independently scheduling the QoS flows.

In multi-UE application scenarios such as newly introduced multi-modal services and federated learning services, the collaborative scheduling for QoS flows is added. For example, adding the candidate configuration set for a Qos flow and adding collaborative scheduling operations in base station. As an example, the base station may schedule and allocate the resources for the plurality of QoS flows according to the one or more collaborative parameter configurations in the candidate configuration set.

The QoS setup/modify request may carry the candidate configuration set for the QoS flow when it is transmitted from the core network to the base station. The candidate configuration set for the QoS flow may be adopted by the base station to configure the QoS flow of the collaborative scheduling scenario.

As an example, when notifying the parameter configuration for the non-collaborative scheduling scenario, the core network may also carry the candidate configuration set for the collaborative scheduling scenario.

As an example, one or more candidate collaborative parameter configurations may be configured for a certain QoS flow for being adopted in the collaborative scheduling scenario. The collaborative scheduling scenario here is a scenario in which the plurality of QoS flows are collaboratively scheduled.

In some cases, some parameters of the collaborative parameter configuration may be the same as or different from those of the non-collaborative parameter configuration for the non-collaborative scheduling application scenario.

As an example, the parameter of the parameter configuration in the non-collaborative scheduling scenario for QoS Flow 1, Packet Delay Budget, is =100 ms.

Meanwhile, the parameter in the collaborative scheduling scenario for QoS Flow 1, Packet Delay Budget, is also given with the parameter value of 50 ms.

Meanwhile, the parameter in the collaborative scheduling scenario for QoS Flow 1, Packet Delay Budget, is also given with the parameter value of 20 ms.

The collaborative control parameters of the QoS flow may be configured by the core network to the base station through explicit signaling, or may be under a protocol agreement.

As an example, the core network may carry one or more parameter configurations for the collaborative scheduling scenario when notifying the parameter configuration for the non-collaborative scheduling scenario. The non-collaborative scheduling scenario means such a scenario where the plurality of QoS flows are not scheduled collaboratively or associated with each other, but each flow is independently scheduled.

In an example, the parameter configuration of the collaborative scheduling scenario is included in the candidate parameter configurations transmitted by the core network and only carries incremental parts (or called difference parts) compared to the non-collaborative parameter configuration, thereby reducing signaling overhead.

As an example, for a certain QoS flow, how to determine its parameter configurations from the collaborative scheduling scenario to the non-collaborative scheduling scenario may be under a protocol agreement. For example, the parameter, Packet Delay Budget, is reduced to a half of the previous.

In this case, the core network may only carry a valid identifier when notifying the parameter configuration of the collaborative scheduling scenario, which means to validate the parameter configuration in the collaborative scheduling scenario.

It is to be noted that, the QoS setup/modify request message initiated by the core network may be one or more of the following messages: a PDU SESSION session resource setup request; a PDU session resource modify request; and an initial context setup request.

After receiving the request for the QoS collaboration requirement transmitted by the core network, the base station adopts the collaborative parameter configuration of the QoS flow.

As an example, the service setup/modify request initiated by the core network is to carry the collaboration control information.

As an example, the collaboration control information indicates whether the core network expects the access network to perform the collaborative scheduling for data flows. The collaboration control information also indicates what kind of collaboration operations the core network expects to perform on the data flows.

In some examples, the collaboration control information may be implicitly carried in grouping information. That is, if the core network notifies the base station that both QoS Flow 1 and QoS Flow 2 of a certain packet data network (PDN) session belong to a group to be collaborated, it is implicitly expressed that the core network expects the QoS collaboration for these two data flows, that is, which candidate configuration set is adopted. In one example, both QoS Flow 1 and QoS Flow 2 are expected to belong to a certain group to be collaborated, which may span multiple terminal devices.

As an example, the candidate configuration set may be under a protocol agreement in advance, or may be explicitly informed by the core network.

As an example, the parameter of the parameter configuration in the non-collaborative scheduling scenario for QoS Flow 1, Packet Delay Budget, is 100 ms; and the parameter of the parameter configuration in the non-collaborative scheduling scenario for QoS Flow 2, Packet Delay Budget, is 100 ms.

When QoS Flow 1 and QoS Flow 2 are collaboratively scheduled: the parameter of Parameter Configuration 1 in the collaborative scheduling scenario for QoS Flow 1 and QoS Flow 2, Packet Delay Budge, is 50 ms.

The collaboration control information may mean what operations on other data flows in the same collaborative packet are expected by the core network when the base station detects the specific trigger event. That is, the modification of one QoS flow affects the parameter modifications of other QoS flows.

As an example, when a certain flow adopting the collaborative parameter configuration fails to meet its QOS requirement, it is likely to cause the QoS parameters of other QoS flows to also be down-regulated or up-regulated. An example is that if the rate of Camera 1 decreases, other cameras that collaborate with it to complete a task may also be compensated by decreasing their acquisition accuracy or increasing their accuracy.

As an example, if the core network notifies the base station that both QoS Flow 1 of a certain PDN session and QoS Flow 2 belong to a certain group to be collaborated, the rate of QoS Flow 1 of the PDN session is lower than a certain threshold, which means that the base station detects the occurrence of Event A.

In this case, where the base station detects that A occurs, the candidate control parameter set adopted for QoS Flow 2 is used (by being down-regulated or up-regulated).

The notification indicating the change of the independent scheduling scenario may also be operations on the data flow expected by the core network when the base station detects the specific triggering event. For example, if it is detected that the rate of QOS Flow 1 is lower than a certain threshold, which means that the base station detects the occurrence of Event B. In this case, where the base station detects that B occurs, other parameter configurations in the candidate non-collaborative parameter set adopted for QoS Flow 1 are used, thereby down-regulating or up-regulating the parameter configuration currently adopted by the QoS flow.

As an example, it may also be taken as the specific trigger event that the base station detects a change in wireless signal quality or in base station load. These cases all mean the changes of the foregoing independent scheduling scenario, and of course, may also be the trigger event for transmitting the foregoing collaboration control information.

As an example, it may be taken as the specific trigger event that the core network notifies the base station through initiating the QoS setup/modify request message.

After receiving the request from the core network for stopping the QoS collaborative scheduling, the base station may fall back to the non-collaborative scheduling scenario and perform the non-collaborative scheduling for the corresponding QoS flow according to the non-collaborative parameter configuration.

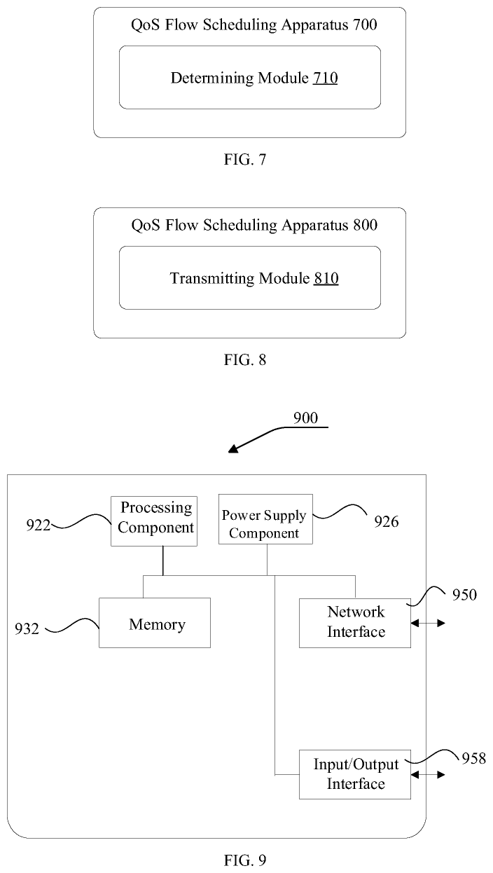

As illustrated in FIG. 7, an example of the present disclosure provides a QoS flow scheduling apparatus 700, which includes a determining module 710:

The determining module 710 is configured to determine a candidate configuration set for a QoS flow. The candidate configuration set includes a plurality of parameter configurations for the QoS flow.

The QoS flow scheduling apparatus may be applied to a first network device that includes an access network such as a base station.

In some examples, the determining module 710 may be a program module. The program module, after executed by a processor, can achieve determining the candidate parameter set for multi-QoS-flow collaborative scheduling.

In another example, the determining module 710 may be a module that combines software and hardware. The module that combines software and hardware includes but is not limited to a programmable array. The programmable array includes but is not limited to a field programmable array and/or a complex programmable array.

In some other examples, the determining module 710 may be a complete hardware module. The complete hardware module includes but is not limited to an application specific integrated circuit.

In some examples, the candidate configuration set includes at least one of the following: one or more collaborative parameter configurations, which are one or more parameter configurations for multi-QoS-flow collaborative scheduling; or one or more non-collaborative parameter configurations, which are one or more parameter configurations for independently scheduling the QoS flow.

In some other examples, the one or more non-collaborative parameter configurations include: a plurality of parameter configurations for independently scheduling the QoS flow in different scenarios.

In some examples, the determining module 710 is configured to receive a QoS request message. The QoS request message includes configuration information on the candidate configuration set for the QoS flow. Alternatively, the determining module 610 is configured to determine the candidate configuration set based on a protocol.

In some examples, the candidate configuration set includes the plurality of parameter configurations, in which the candidate configuration set includes a reference parameter configuration and one or more difference configurations, and the one or more difference configurations indicate differences of one or more non-reference parameter configurations in the plurality of parameter configurations relative to the reference parameter configuration, respectively.

Alternatively, the candidate configuration set includes the plurality of parameter configurations, in which the candidate configuration set includes a reference parameter configuration and one or more conversion relationship configurations, and the one or more conversion relationship configurations indicate conversion relationships between the reference parameter configuration and one or more non-reference parameter configurations in the plurality of parameter configurations, respectively.

In some examples, the conversion relationships between one or more parameters of the reference parameter configuration and the same parameters of the one or more non-reference parameter configuration indicates at least one of the following: ratios between the one or more parameters of the reference parameter configuration and the same parameters of the non-reference parameter configuration; differences between the one or more parameters of the reference parameter configuration and the same parameters of the non-reference parameter configuration; or conversion functions between the one or more parameters of the reference parameter configuration and the same parameters of the non-reference parameter configuration.

As an example, the candidate configuration set indicates the one or more collaborative parameter configurations and the one or more non-collaborative parameter configurations, in which the candidate configuration set includes a non-collaborative parameter configuration and one or more first difference configurations, and the one or more first difference configurations indicate the difference configurations of the one or more collaborative parameter configurations relative to the non-collaborative parameter configuration, respectively.

Alternatively, the candidate configuration set indicates the one or more collaborative parameter configurations and the one or more non-collaborative parameter configurations, in which the candidate configuration set includes a collaborative parameter configuration and one or more second difference parameter configurations, and the one or more second difference configurations include the difference configurations of the one or more non-collaborative parameter configurations relative to the collaborative parameter configuration, respectively.

As another example, the candidate configuration set indicates the one or more collaborative parameter configurations and the one or more non-collaborative parameter configurations, in which the candidate configuration set includes a non-collaborative parameter configuration and one or more first conversion identifiers, and the one or more first conversion identifiers indicate the conversion relationships between the non-collaborative parameter configuration and the one or more collaborative parameter configurations, respectively.

Alternatively, the candidate configuration set indicates the one or more collaborative parameter configurations and the one or more non-collaborative parameter configurations, in which the candidate configuration set includes a collaborative parameter configuration and one or more second conversion identifiers, and the one or more second conversion identifiers indicate the conversion relationships between the one or more non-collaborative parameter configurations and the collaborative parameter configuration, respectively.

In some examples, the QOS request message includes at least one of the following: a QoS setup request message; or a QoS modify request message.

In some examples, the apparatus further includes a collaborative scheduling module that is configured to collaboratively schedule, in response to determining a QoS flow collaborative scheduling requirement, at least two QoS flows according to the one or more collaborative parameter configurations.

In some examples, the apparatus further includes a collaborative scheduling requirement module that is configured to determine, in response to receiving collaboration control information, that there is the QoS flow collaborative scheduling requirement.

In some examples, the receiving module is configured to receive a service request message including the collaboration control information.

In some examples, the service request message includes at least one of the following: a service setup request message; or a service modify request message.

In some examples, the collaboration control information further indicates the one or more QoS flows to be collaboratively scheduled.

In some examples, the collaboration control information is determined based on grouping information of a plurality of QoS flows.

In some examples, the apparatus further includes a restoring module that is configured to restore, in response to receiving non-collaboration control information, to independently schedule the at least two QoS flows that is being collaboratively scheduled

In some examples, the apparatus further includes an independent scheduling module that is configured to adjust, in response to a change in an independent scheduling scenario and according to the one or more non-collaborative parameter configurations, the parameter configuration being adopted for independently scheduling the QoS flow.

In some examples, the apparatus further includes a scenario changing module that is configured to determine, in response to receiving a notification on a triggering event, the change in the independent scheduling scenario.

In some examples, the notification is carried in a service request message.

In some examples, the service request message includes at least one of the following: a service setup request message; or a service modify request message.

In some examples, the notification further indicates one or more QoS flows whose independent scheduling scenarios change.

In some examples, the apparatus further includes an initial parameter configuration restoring module that is configured to restore, in response to receiving a notification that an independent scheduling scenario is restored, to initial parameter configuration for independently scheduling the QoS flow.

As illustrated in FIG. 8, an example of the present disclosure provides a QoS flow scheduling apparatus 800, which includes a transmitting module 810.

The transmitting module 810 is configured to transmit a QoS request message indicating a candidate configuration set for a QoS flow.

The candidate configuration set includes a plurality of parameter configurations for the QoS flow.

In some examples, the transmitting module 810 may be a program module. The program module, after executed by a processor, can achieve transmitting the QoS request message.

In some examples, the transmitting module 810 may be a module that combines software and hardware. The module that combines software and hardware includes but is not limited to a programmable array. The programmable array includes but is not limited to a field programmable array and/or a complex programmable array.

In some other examples, the transmitting module 810 may be a complete hardware module. The complete hardware module includes but is not limited to an application specific integrated circuit.

In some examples, the candidate configuration set includes at least one of the following: one or more collaborative parameter configurations, which are one or more parameter configurations for multi-QoS-flow collaborative scheduling; or one or more non-collaborative parameter configurations, which are one or more parameter configurations for independently scheduling the QoS flow.

In some examples, the one or more non-collaborative parameter configurations include a plurality of parameter configurations for independently scheduling the QoS flow in different scenarios.

In some examples, the candidate configuration set includes the plurality of parameter configurations, in which the candidate configuration set includes a reference parameter configuration and one or more difference configurations, and the one or more difference configurations indicate differences of one or more non-reference parameter configurations in the plurality of parameter configurations relative to the reference parameter configuration, respectively.

Alternatively, the candidate configuration set includes the plurality of parameter configurations, in which the candidate configuration set includes a reference parameter configuration and one or more conversion relationship configurations, and the one or more conversion relationship configurations indicate conversion relationships between the reference parameter configuration and one or more non-reference parameter configurations in the plurality of parameter configurations, respectively.

In some examples, the conversion relationships between the non-reference parameter configuration and the reference parameter configuration indicate at least one of the following: ratios between the one or more parameters of the reference parameter configuration and the same parameters of the non-reference parameter configuration; differences between the one or more parameters of the reference parameter configuration and the same parameters of the non-reference parameter configuration; or conversion functions between the one or more parameters of the reference parameter configuration and the same parameters of the non-reference parameter configuration.

As an example, the candidate configuration set indicates the one or more collaborative parameter configurations and the one or more non-collaborative parameter configurations, in which the candidate configuration set includes a non-collaborative parameter configuration and one or more first difference configurations, and the one or more first difference configurations indicate the difference configurations of the one or more collaborative parameter configurations relative to the non-collaborative parameter configuration, respectively.

Alternatively, the candidate configuration set indicates the one or more collaborative parameter configurations and the one or more non-collaborative parameter configurations, in which the candidate configuration set includes a collaborative parameter configuration and one or more second difference parameter configurations, and the one or more second difference configurations include the difference configurations of the one or more non-collaborative parameter configurations relative to the collaborative parameter configuration, respectively.

As another example, the candidate configuration set indicates the one or more collaborative parameter configurations and the one or more non-collaborative parameter configurations, in which the candidate configuration set includes a non-collaborative parameter configuration and one or more first conversion identifiers, and the one or more first conversion identifiers indicate the conversion relationships between the non-collaborative parameter configuration and the one or more collaborative parameter configurations, respectively.

Alternatively, the candidate configuration set indicates the one or more collaborative parameter configurations and the one or more non-collaborative parameter configurations, in which the candidate configuration set includes a collaborative parameter configuration and one or more second conversion identifiers, and the second conversion identifiers indicate the conversion relationships between the one or more non-collaborative parameter configurations and the collaborative parameter configuration, respectively.

In some examples, the QOS request message includes at least one of the following: a QoS setup request message; or a QoS modify request message.

In some examples, the apparatus further includes: a collaboration control information module that is configured to transmit, in response to a QoS flow collaborative scheduling requirement, collaboration control information. The collaboration control information indicates the collaborative scheduling requirement.

In some examples, the collaboration control information module is configured to transmit a service request message including the collaboration control information.

In some examples, the apparatus further includes a collaborative scheduling requirement module. The collaborative scheduling requirement module is configured to perform at least one of the following: in response to a QoS value of at least one of the plurality of QoS flows being lower than a QoS threshold, determining that there is the QoS flow collaborative scheduling requirement; in response to the QoS value of each of the plurality of QoS flows reaching the QoS threshold after the QoS value of at least one of the plurality of QoS flows changes, determining that there is the QoS flow collaborative scheduling requirement; in response to a resource allocation failure for at least one of the plurality of QoS flows, determining that there is the QoS flow collaborative scheduling requirement; or in response to a resource allocation failure for each of the plurality of QoS flows, determining the QoS flow collaborative scheduling requirement.

In some examples, the collaboration control information is further used for QoS flows to be collaboratively scheduled.

In some examples, the apparatus further includes a non-collaboration control information module that is configured to transmit, in response to a disappearance of the requirement for collaboratively scheduling a plurality of QoS flows, non-collaboration control information. The non-collaboration control information indicates to restore to independently schedule the plurality of QoS flows.

In some examples, the transmitting module is further configured to transmit, in response to the disappearance of the requirement for collaboratively scheduling the plurality of QoS flows, the non-collaboration control information that indicates to restore to independently schedule the plurality of QoS flows.

In some examples, the transmitting module is configured to transmit, in response to a change in an independent scheduling scenario, a notification on the change in the independent scheduling scenario.

In some examples, the notification includes that a triggering event occurs.

In some examples, the notification is carried in a service request message.

In some examples, the service request message includes at least one of the following: a service setup request message; or a service modify request message.

In some examples, the notification further indicates one or more QoS flows whose independent scheduling scenarios change.

In some examples, the transmitting module is further configured to transmit a notification indicating that the independent scheduling scenario is restored.

An example of the present disclosure provides a network device, including: a memory for storing instructions executable by a processor; and a processor connected to the memory. The processor is configured to perform the QoS flow scheduling method provided by any of the foregoing technical solutions.

The memory may include a storage medium of various types. The storage medium is a non-transitory computer storage medium that is capable of keeping information stored thereon after the network device is powered off.

The network device here includes an access network device of an access network and/or a core network device of a core network.

The processor may be connected to the memory through a bus or the like, and may be used to read an executable program stored on the memory, for example, at least one of the methods illustrated in FIG. 2A, FIG. 2B, FIG. 3A, FIG. 3B, and FIGS. 4 to 6.

As illustrated in FIG. 9, an example of the present disclosure illustrates a structure of a network device. For example, the network device 900 may be provided as a network side device. The network device may be the foregoing access network device and/or core network device.

In referring to FIG. 9, the network device 900 includes a processing component 922 which further includes one or more processors, and a memory resource represented by a memory 932 which is used to store instructions that may be executed by the processing component 922, such as application programs. The application programs stored in the memory 932 may include one or more modules, each of which corresponds to a set of instructions. In addition, the processing component 922 is configured to execute instructions to perform any of the foregoing methods which are applied to the access network device and/or the core network device, for example, the methods illustrated in FIG. 2A, FIG. 2B, FIG. 3A, FIG. 3B, and FIGS. 4 to 6.

The network device 900 may also include a power supply component 926 configured to perform power management for the network device 900, a wired or wireless network interface 950 configured to connect the network device 900 to a network, and an input/output (I/O) interface 958. The network device 900 may operate based on an operating system stored in memory 932, such as Windows Server™, Mac OS X™, Unix™, Linux™, FreeBSD™ or the like.

An example of the present disclosure also provided a non-transitory computer-readable storage medium including instructions, such as the memory 932 including instructions. These instructions may be executed by the processing component 922 of the network device to complete the foregoing methods. For example, the non-transitory computer-readable storage medium may be ROM, random access memory (RAM), CD-ROM, magnetic tape, floppy disk, optical data storage device, and the like.

After the instructions are executed by the processor, the QoS flow scheduling method provided by any of the foregoing technical solutions can be implemented. For example, at least one of the methods illustrated in FIG. 2A, FIG. 2B, FIG. 3A, FIG. 3B, and FIGS. 4 to 6 is performed.

According to the technical solutions provided by the examples of the present disclosure, the first network device determines a candidate configuration set for scheduling a QoS flow. The candidate configuration set may include a plurality of parameter configurations. These parameter configurations may be adopted for scheduling the QoS flow in different scenarios, so as to achieve scheduling the QoS flow in different scenarios, thereby meeting the requirements for scheduling the QoS flow in different scenarios.

Other implementations of the present disclosure will be readily apparent to those skilled in the art after implementing the disclosure by referring to the specification. The present disclosure is intended to cover any variations, uses, or adaptations of the present disclosure that are in accordance with the general principles thereof and include common general knowledge or conventional technical means in the art that are not disclosed in the present disclosure. The description and the examples are only illustrative, and the true scope and spirit of the present disclosure are set forth in the appended claims.

It is to be understood that the present disclosure is not limited to the above described accurate structures illustrated in the drawings, and various modifications and changes can be made to the present disclosure without departing from the scope thereof. The scope of the present disclosure is to be limited only by the appended claims.

1. A quality of service (QOS) flow scheduling method, performed by a first network device, comprising:
determining a candidate configuration set for a QoS flow,
wherein the candidate configuration set comprises a plurality of parameter configurations for the QoS flow.

2. The QoS flow scheduling method according to claim 1, wherein the candidate configuration set comprises at least one of:
one or more collaborative parameter configurations, which are one or more parameter configurations for multi-QoS-flow collaborative scheduling; or
one or more non-collaborative parameter configurations, which are one or more parameter configurations for independently scheduling the QoS flow;
wherein the one or more non-collaborative parameter configurations comprise a plurality of parameter configurations for independently scheduling the QoS flow in different scenarios.

3. (canceled)

4. The QoS flow scheduling method according to claim 1, wherein determining the candidate configuration set for the QoS flow comprises:
receiving a QoS request message, wherein the QoS request message comprises configuration information on the candidate configuration set for the QoS flow, and wherein wherein the Qos request message comprises at least one of a QoS setup request message or a QoS modify request message; or
determining the candidate configuration set based on a protocol.

5. The QoS flow scheduling method according to claim 1, wherein
the candidate configuration set comprises a reference parameter configuration and one or more difference configurations, and the one or more difference configurations indicate differences of one or more non-reference parameter configurations in the plurality of parameter configurations relative to the reference parameter configuration, respectively; or
the candidate configuration set comprises a reference parameter configuration and one or more conversion relationship configurations, and the one or more conversion relationship configurations indicate conversion relationships between the reference parameter configuration and one or more non-reference parameter configurations in the plurality of parameter configurations, respectively;
wherein for each non-reference parameter configuration, the conversion relationships indicate at least one of:
ratios between the one or more parameters of the reference parameter configuration and same parameters of the non-reference parameter configuration;
differences between the one or more parameters of the reference parameter configuration and same parameters of the non-reference parameter configuration; or
conversion functions between the one or more parameters of the reference parameter configuration and same parameters of the non-reference parameter configuration.

6.-7. (canceled)

8. The QoS flow scheduling method according to claim 2, further comprising:
collaboratively scheduling, based on determining that there is a QoS flow collaborative scheduling requirement, at least two QoS flows to be collaboratively scheduled according to the one or more collaborative parameter configurations, wherein the at least two QoS flows to be collaboratively scheduled comprise the QoS flow.

9. The QoS flow scheduling method according to claim 8, further comprising:
receiving a service request message comprising collaboration control information;
determining that there is the QoS flow collaborative scheduling requirement, or that there is the QoS flow collaborative scheduling requirement and the at least two QoS flows to be collaboratively scheduled;
wherein the service request message comprises at least one of a service setup request message or a service modify request message;
wherein the at least two QoS flows to be collaboratively scheduled are indicated by the collaboration control information.

10.-12. (canceled)

13. The QoS flow scheduling method according to claim 9, wherein the collaboration control information is determined based on grouping information of a plurality of QoS flows.

14. The QoS flow scheduling method according to claim 2, further comprising:
restoring, based on receiving non-collaboration control information, to independently schedule at least two QoS flows that is being collaboratively scheduled;
wherein he at least two QoS flows that is being collaboratively scheduled comprises the QoS flow.

15. The QoS flow scheduling method claim 2, further comprising:
adjusting, based on a change in an independent scheduling scenario and according to the one or more non-collaborative parameter configurations, the one or more non-collaborative parameter configuration being adopted for independently scheduling the QoS flow.

16. The QoS flow scheduling method according to claim 15, further comprising:
determining, based on receiving a notification on a triggering event, the change in the independent scheduling scenario;
wherein the notification is carried in a service request message;
wherein the service request message comprises at least one of a service setup request message; or a service modify request message.

17.-19. (canceled)

20. The QoS flow scheduling method according to claim 15, further comprising:
transmitting a notification indicating that the independent scheduling scenario is restored;
restoring to initial parameter configuration for independently scheduling the QoS flow.

21. A quality of service (QOS) flow scheduling method, performed by a second network device, comprising:
transmitting a QoS request message indicating a candidate configuration set for a QoS flow,
wherein the candidate configuration set comprises a plurality of parameter configurations for the QoS flow.

22. The QoS flow scheduling method according to claim 21, wherein the candidate configuration set comprises at least one of:
one or more collaborative parameter configurations, which are one or more parameter configurations for multi-QoS-flow collaborative scheduling; or
one or more non-collaborative parameter configurations, which are one or more parameter configurations for independently scheduling the QoS flow;
wherein the one or more non-collaborative parameter configurations comprise a plurality of parameter configurations for independently scheduling the QoS flow in different scenarios.

23. (canceled)

24. The QoS flow scheduling method according to claim 21, wherein
the candidate configuration set comprises a reference parameter configuration and one or more difference configurations, wherein the one or more difference configurations indicate differences of one or more non-reference parameter configuration in the plurality of parameter configurations relative to the reference parameter configuration, respectively; or
the candidate configuration set comprises a reference parameter configuration and one or more conversion relationship configurations, and the one or more conversion relationship configurations indicate conversion relationships between the reference parameter configuration and one or more non-reference parameter configurations in the plurality of parameter configurations, respectively;
wherein for each non-reference parameter configuration, the conversion relationships between one or more parameters of the reference parameter configuration and same parameters of the one or more non-reference parameter configurations indicate at least one of:
ratios between the one or more parameters of the reference parameter configuration and the same parameters of the non-reference parameter configuration;
differences between the one or more parameters of the reference parameter configuration and the same parameters of the non-reference parameter configuration; or
conversion functions between the one or more parameters of the reference parameter configuration and the same parameters of the non-reference parameter configuration.

25. (canceled)

26. The QoS flow scheduling method according to claim 21, wherein the QoS request message comprises at least one of:
a QoS setup request message; or
a QoS modify request message.

27. The QoS flow scheduling method according to claim 21, further comprising:
transmitting, based on a QoS flow collaborative scheduling requirement, collaboration control information;
wherein the collaboration control information indicates the collaborative scheduling requirement, or indicates the collaborative scheduling requirement and at least two QoS flows to be collaboratively scheduled;
wherein the at least two QoS flows to be collaboratively scheduled comprises the QoS flow.

28. The QoS flow scheduling method according to claim 27, wherein transmitting the collaboration control information comprises:
transmitting a service request message comprising the collaboration control information;
wherein the QoS flow method further comprises at least one of:
determining, based on a QoS value of at least one of a plurality of QoS flows being lower than a QoS threshold, that there is the QoS flow collaborative scheduling requirement;
determining, based on the QoS value of each of the plurality of QoS flows reaching the QoS threshold after the QoS value of at least one of the plurality of QoS flows changes, that there is the QoS flow collaborative scheduling requirement;
determining, based on a resource allocation failure for at least one of the plurality of QoS flows, that there is the QoS flow collaborative scheduling requirement; or
determining, based on a resource allocation failure for each of the plurality of QoS flows, that there is the QoS flow collaborative scheduling requirement.

29.-30. (canceled)

31. The QoS flow scheduling method according to claim 21, further comprising:
transmitting, based on a disappearance of collaborative scheduling requirement for at least two QoS flows, non-collaboration control information;
wherein the non-collaboration control information indicates to restore to independently schedule the at least two QoS flows;
wherein the at least two QoS flows comprise the QoS.

32. The QoS flow scheduling method according to claim 21, further comprising:
transmitting, based on a change in the independent scheduling scenario, a notification that indicates the change in the independent scheduling scenario;
wherein the notification comprises that a triggering event occurs;
wherein the notification is carried in a service request message;
wherein the service request message comprises at least one of a service setup request message; or a service modify request message; and
wherein the notification further indicates one or more QoS flows whose independent scheduling scenarios change.

33.-74. (canceled)

75. A network device, comprising:
a transceiver,
a memory, and
one or more processors that are communicatively coupled to the transceiver and the memory, wherein the one or more processors are collectively configured to:
determine a candidate configuration set for a QoS flow,
wherein the candidate configuration set comprises a plurality of parameter configurations for the QoS flow.

76. (canceled)
